(19) United States
(12) Patent Application Publication
(10) Pub. No.: US 2026/0351875 A1
(43) Pub. Date: Nov. 5, 2026

(54) LIQUID METAL CIRCUIT BOARD CONNECTORS

(71) Applicant: Nvidia Corporation, Santa Clara, CA (US)

(72) Inventors: John Andrew Norton, Houston, TX (US); Karl Joseph Bois, Fort Collins, CO (US); Michael David Herring, Apex, NC (US); Joseph Michael Gallo, Littleton, MA (US)

(21) Appl. No.: 19/222,758

(22) Filed: May 29, 2025

Related U.S. Application Data
(60) Provisional application No. 63/798,384, filed on May 1, 2025.

(51) Int. Cl. H01R 12/71; H01R 3/08; H01R 13/52; H01R 43/00; H01R 43/20

(52) U.S. Cl. CPC H01R 12/716; H01R 3/08; H01R 13/521; H01R 43/005; H01R 43/205

(57) ABSTRACT

Systems and methods disclosed herein are for circuit board assembly which may include a receiving connector formed, in part, by vias within a printed circuit board (PCB). The vias may include a liquid metal that is liquid at operating temperatures of components of the PCB. The receiving connector may receive pins of an external connector into the vias. The liquid metal is to make up an electrical connection with the pins.

### CROSS-REFERENCE TO RELATED APPLICATION(S)

This is a non-provisional application that is related to and that claims the benefit of priority from U.S. provisional patent application Ser. No. 63/798,384, filed May 1, 2025, and entitled “LIQUID METAL CIRCUIT BOARD CONNECTORS,” the entire contents of which is incorporated by reference herein and form a part of this specification for all intents and purposes.

### BACKGROUND

A circuit board, such as a printed circuit board (PCB), may have a receiving connector to be associated with an external connector that uses compression pins to make up electrical connections.

### BRIEF DESCRIPTION OF THE DRAWINGS

Various embodiments in accordance with the present disclosure will be described with reference to the drawings, in which:

FIG. 1A illustrates a cross-section view of a circuit board assembly having liquid metal circuit board connectors, in accordance with at least some embodiments;

FIG. 1B illustrates a perspective through-section view of a circuit board assembly having liquid metal circuit board connectors, in accordance with at least some embodiments;

FIG. 1C illustrates detailed aspects of liquid metal circuit board connectors, in accordance with at least some embodiments;

FIG. 1D illustrates aspects of a receiving connector having vias with liquid metal, in accordance with at least some embodiments;

FIG. 2A illustrates a connection between two circuit boards and is used for signaling by liquid metal circuit board connectors, in accordance with at least some embodiments.

FIG. 2B illustrates a connector between a daughter board and a backplane or a midplane, in accordance with at least some embodiments;

FIG. 3A illustrates a process or method for liquid metal circuit board connectors, in accordance with at least some embodiments;

FIG. 3B illustrates a process or method for liquid metal circuit board connectors, in accordance with at least some embodiments;

FIG. 4 illustrates an example datacenter to apply at least one embodiment for power connection in FIGS. 1A-3B and 5-7;

FIG. 5 illustrates aspects of an example rack to apply at least one embodiment in FIGS. 1A-4 and 6A-7;

FIG. 6A illustrates an example datacenter system, according to at least some embodiments;

FIG. 6B is a block diagram that schematically illustrates a computing system that may be a datacenter or a High-Performance Computing (HPC) cluster, in which at least one embodiment described herein may be used;

FIG. 6C illustrates a computer system, according to at least one example, in which at least one embodiment described herein may be used; and

FIG. 7 illustrates an example network configuration of components that can be used to implement aspects of various embodiments, such as to provide, generate, modify, encode, process, fuse, and/or transmit generated image data, calculated measurements, or other such content.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

One example of an external connector may be a lead frame connector. Another example of the external connector may be a power connector. A lead frame connector may be a bridge connector that may be used between circuit boards (also referred to herein as printed circuit boards (PCBs)). A power connector may be used to provide power to a PCB and to its components. The PCBs may be daughter boards (or cards) and backplanes or midplanes of a rack in a datacenter. In one example, each lead frame connector may include multiple pins and each of the multiple pins may be used for differential signaling. Each of the multiple pins may be coupled to corresponding receiving vias of a receiving connector. As used herein, a receiving connection may be in reference to an areas on a PCB having vias coupled to signal or power lines of the PCB to allow transfer of signal or power from an external connector to one or more components of the PCB. The vias may be provided within the PCB. In one example, the receiving connector may be defined by the area having the vias. This approach allows bindings on the PCB, supported by the vias which are filled with a liquid metal. The pins into the bindings, along with a surface tension of the liquid metal, make up the electrical connection between the PCB and a connector having the pins. A seal or gasket interface, such as a low durometer rubber or closed cell foam, ensures that the liquid metal remains in place. In one example, the liquid metal is a viscous liquid metal but allows for surface tension with higher density of vias.

In one example, a circuit board assembly may include the PCB having a receiving connector formed of vias within the PCB. The vias may be filled with, in part, a liquid metal. The liquid metal may act as a conductive medium and uses, in part, surface tension to ensure contact with pins of an external connector to make up an electrical connection between an external device and the PCB. Further, a gasket interface, provided by a seal, may be between the receiving connector, the external connector, and the PCB. The gasket interface allows maintenance of a seal to prevent extrusion of the liquid metal.

The gasket interface may be of a low durometer measure of hardness and may be subject to compression to ensure the seal, in one example. The gasket interface may be the only interface, between the receiving connector and the external connector, that is subject to compression. A benefit realized is that a compression force to ensure the seal through the gasket interface may be less than a compression force otherwise required to maintain a compression contact for hard metal connectors, such as a pin inserted with full contact against side of a receiving socket. In one example, the seal may be determined for use with the circuit board assembly based at least in part on its material being in a range of durometer measures which is predetermined. The predetermined range may be based at least in part on a first compression required for the seal being less than a second compression required for a comparable hard metal connector interface between the pins and the PCB. The first compression must be to prevent extrusion of the liquid metal from between the receiving connector, the external connector, and the PCB.

The liquid metal may essentially be a liquid at operating temperatures of the PCB. The operating temperatures may include at least a temperature in which components on the PCB are subject to a workload. The liquid metal may include gallium-based composition or a metal-based thermal interface metal (TIMs) which are liquid at the operating temperatures of the PCB. The liquid metal may include properties of being electrically conductive and being wettable, with respect to metallic surfaces (such as those of the pins). Further, other than for power connection, the receiving connectors of the PCB may also enable a stubless connection for high data rate communication applications. While a stub may be an unused portion of a via when a signal transitions between layers of a PCB, the stubless connection herein may be in reference to the vias formed with liquid metal therein for terminations of a signal allowed from both sides of the PCB. For example, the via having liquid metal may be connected with a pin of a component or a connector from a first side with a seal on a second side, with a further connection from the second side performed separately or at the same time as the first side using another pin from another component or connector.

A problem addressed by the circuit board assembly having liquid metal circuit board connectors is that a PCB may otherwise use or need connection pins subject to continuous compression to make up electric connections. For example, the connection pins may require high compressive forces to compress the pins against a receiving socket of a receiving connector to ensure electrical contact. In addition, a PCB's receiving connector may be a stubbed interface, where the stubs may impact signal integrity if the electrical connection made up is used for communications-particularly, as a result of reflective signal interference from signal bouncing within the stubs. Further, the compressive forces through the connectors may be high enough to cause warpage in the PCB and in the connectors. This may be a design, reliability and yield challenge for PCBs. A circuit board assembly having liquid metal circuit board connectors allows the use of a liquid metal within vias of the PCB to make up electrical connections such that the only compressive force-which is used to seal the liquid metal-is less than the compressive force otherwise required for hard connectors to make up the same electrical connections. This design addresses issues of warpage and signal integrity associated with high-force connections by employing surface tension for contact, thus creating a stubless interface that enhances electrical connectivity without the need for substantial compression forces.

The systems and methods described herein may be used for a variety of purposes, by way of example and without limitation, for machine control, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, datacenter processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed examples herein may be comprised in a variety of different systems such as, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a datacenter, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

In one example, computing devices or components on a PCB benefiting from the lead frame connectors herein may include processors of different types. The processors may include central processing units (CPUs), graphics processing units (GPUs), data processing units (DPUs), quantum processing units (QPUs), parallel processing units (PPUs), and application-specific integrated circuits (ASICs). QPUs may be configured to perform one or more operations associated with a quantum algorithm. In some examples, each of the one or more QPUs may include qubits. One or more QPUs may be in communication with each other via a quantum channel. In some examples, each of the qubits may include local qubits, global qubits, and/or synchronization qubits. In some examples, the local qubits of each QPU may be configured to perform the one or more operations associated with the quantum algorithm on the QPU that are associated with the local qubits.

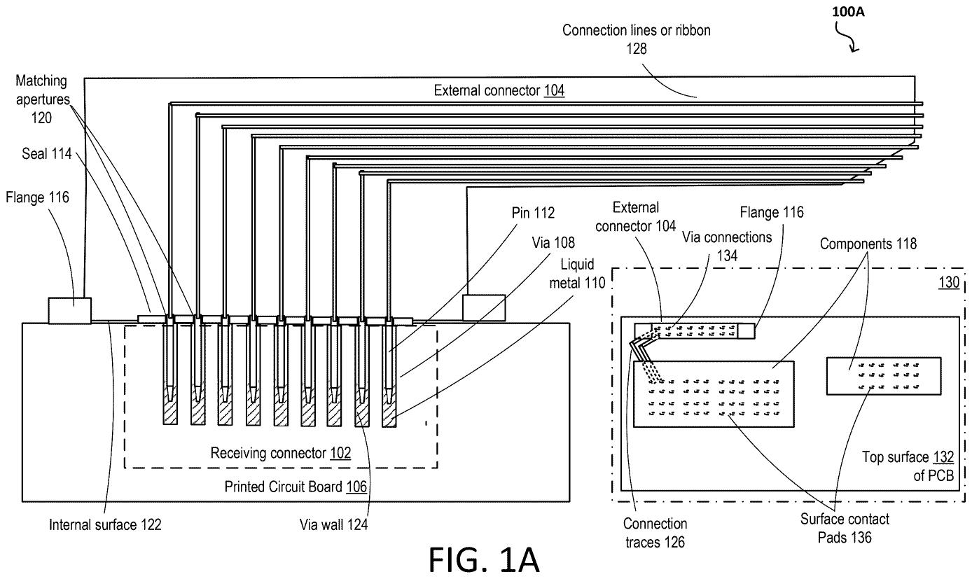

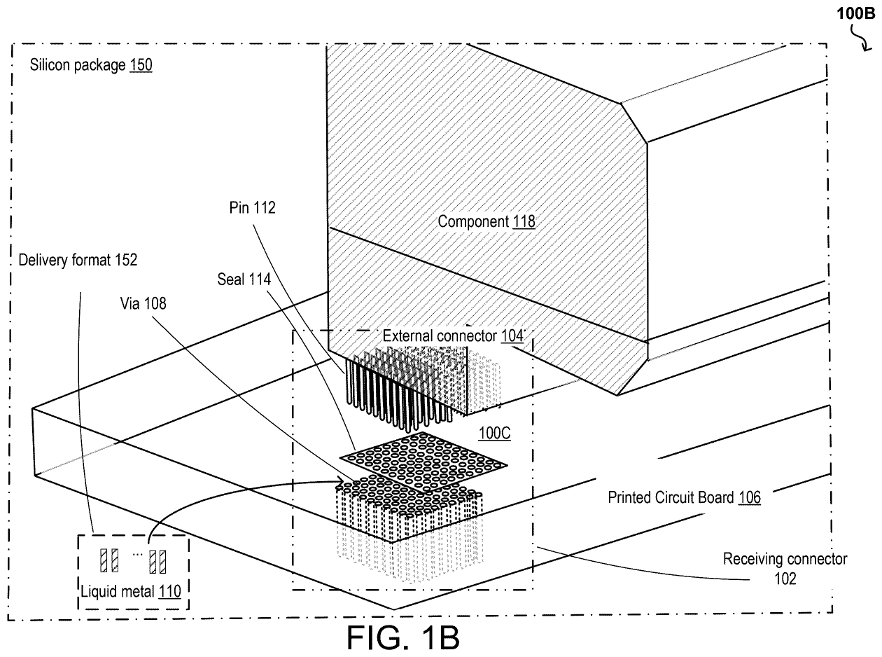

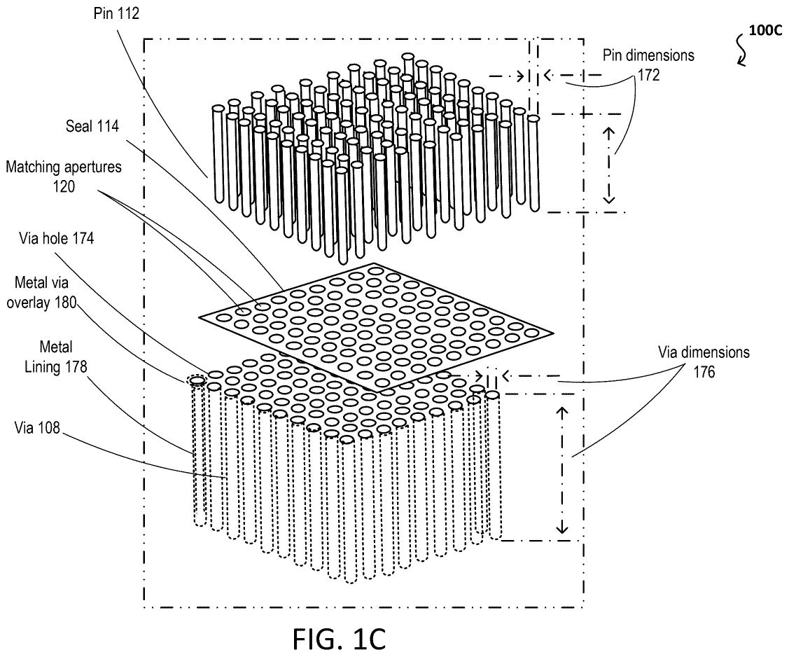

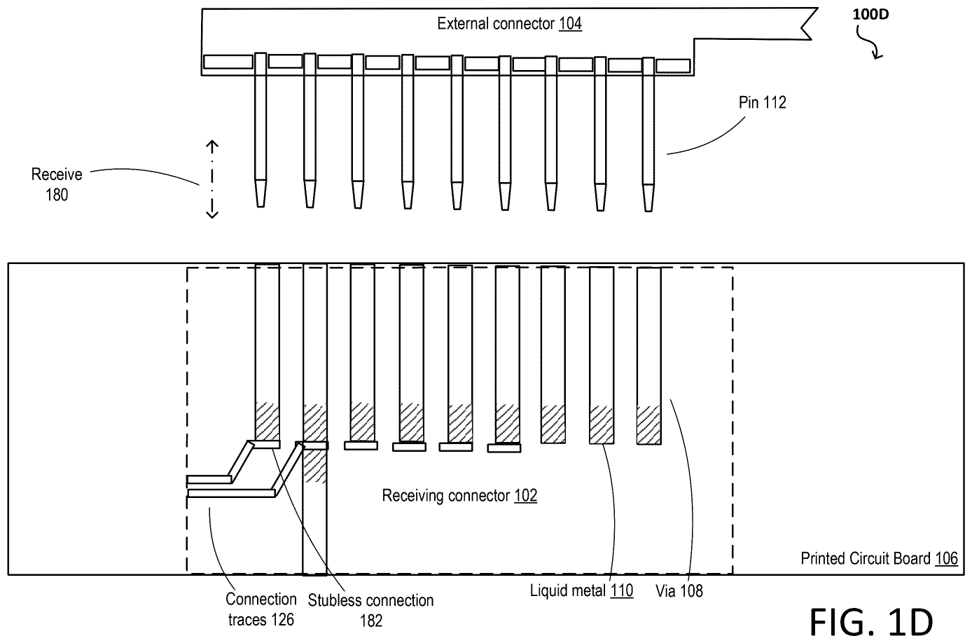

FIG. 1A illustrates a cross-section view 100A of a circuit board assembly having liquid metal circuit board connectors, in accordance with at least some embodiments. The circuit board assembly may include a receiving connector 102, which may be defined in part or formed in part by vias 108 which may be within a PCB 106. The PCB 106 may include components 118 to perform aspects of a workload, in one example. The components 118 may be processors, switches, memory, and other aspects required to perform the workload. The vias 108 may include a liquid metal 110 which may be a liquid at operating temperatures of components 118 of the PCB 106. The receiving connector may also be able to receive pins 112 of an external connector 104 into the vias 108. The liquid metal 110 may be used, in the circuit board assembly, to make up an electrical connection with the pins 112.

In one example, the circuit board assembly may also include a seal 114, which may provide a gasket interface between the PCB 106 and the external connector 104. The seal may include material of a range of durometer measures which may be predetermined. For example, the predetermined range of durometer measures may be based, at least in part, on a first compression required of the seal to prevent extrusion of the liquid metal 110 from between the receiving connector 102, the external connector 104, and the PCB 106. In addition, the predetermined range of durometer measures may be also based in part on the first compression being necessarily less than a second compression required for a comparable hard metal connector interface between the pins 112 and the PCB 106.

In one example, one or more compression forces to connect the pins 112 to a receiving socket and to maintain the connection may be studied as part of an actual test or a simulation. The compression forces may be different for different connectors having different numbers of pins, for different applications having different dimensions of pins, or for different orientations of connection interfaces between the receiving connector and an external connector. The actual test or the simulation may account for all such compression forces. Once determined, the seal may be selected from seals of a predetermined range of durometer measures relating to hardness, for example, of an underlying material. The underlying material may be an elastomer, in one example. An amount of compression force required for the predetermined range of durometer measures, to hold the seal 114 between the receiving connector 102 and the external connector 104 and to retain the liquid metal 110 in the vias 108 is necessarily less than the compression forces required to hold and maintain the comparable hard metal connector interface between the pins 112 and the PCB 106.

In another example, the circuit board assembly may include the seal 114 which is such that it has matching apertures 120 to allow the pins 112 therethrough and to sit between the receiving connector 102, the external connector 104, and the PCB 106. The circuit board assembly may include a liquid metal 110 that is one of a gallium-based composition or a metal-based thermal interface metal (TIMs). The gallium-based composition or the metal-based TIM may be liquid at an operating temperature of the PCB 106.

The circuit board assembly may be such that the external connector 104 may be provided with a flange 116 and with an internal surface 122 to overlay the receiving connector 102. As illustrated, the receiving connector 102 may not be a distinct connector from the PCB 106, but may be a three-dimension (3D) area of the PCB 106 which includes the vias 108. The external connector 104 may be adapted to compress the seal 114 against the receiving connector 104, while being devoid of a compression force through the pins 112 within the vias 108. For example, as illustrated, a gap may be maintained below the pins 112 in the vias 108. In another example, a gap may be maintained between the pins 112 and the via walls 124 of the vias 108. In yet another example, the pins 112 may displace at least part of the liquid metal 110 to the gaps of at least the via walls 124. Relative to a hard metal connector interface between pins and a receiving sockets, as there is not compression between the pins 112 and the via walls 124, there is no compression required, which can ensure that such liquid metal circuit board connectors are devoid of a reflective signal interference from signal bouncing within stubs of the connectors.

In one example, the circuit board assembly may be such that the liquid metal 110 is to make up the electrical connection with the pins 112 based in part on a surface tension available within the liquid metal 110. There need not be a displacement of the liquid metal 110. Instead, surface tension of the liquid metal 110 may cause adherence of liquid metal 110 to the pins 112. The electrical connection may be allowed between connection lines or a ribbon 128 of the external connector 104 and components 118 of the PCB 106. The electrical connection may be provided via the pins 112 of the external connector 104, the liquid metal 110 of the receiving connector 102, the connection traces 126 of the PCB 106, and the surface contact pads to which the components 118 are connected. In another example, the circuit board assembly may be such that the vias 108 which include the liquid metal are stubless. The stubless nature allows the electrical connection to occur at a data rate communication that is free of reflective signal interference between the receiving connector 102 and the external connector 104.

FIG. 1A also illustrates, in callout 130, that a top surface 132 of the PCB 106 may include the components 118 connected, via surface contact pads 136, to connection traces 126. In some examples, the connection traces 126 may be interconnects, including interconnects within a silicon package. The connection traces 126 may be laid on the top surface 132 of the PCB 106 and may connect between via connections 134 formed between the receiving connector 102 and the external connector 104. The via connections 134 may include a metal surface which may also line walls of the via 108 (such as in FIG. 1C) to electrically conduct between the pin 112, the liquid metal 110, and the connection traces 126. In another example, the connection traces 126 may be layered within the PCB 106 and may connect to a bottom of or to connect elsewhere within the via 108 and to the liquid metal 110.

FIG. 1B illustrates a perspective through-section view 100B of a circuit board assembly having liquid metal circuit board connectors, in accordance with at least some embodiments. The perspective through-section view 100B may be of the circuit board assembly in FIG. 1A, in one example. In another example, the perspective through-section view 100B may be of a silicon package 150. A silicon package 150 may be a system on a chip (SoC), in one example. The silicon package 150 may include a receiving connector 102 102 formed, in part, by vias 108 within the silicon package 150. The vias 108 may be within a PCB 106 forming a base of the silicon package 150.

In one example, the PCB 106 may support connection traces 126 on both sides of the PCB 106. In this example, the vias 108 may be provided from both sides of the PCB 106. The vias 108 may be staggered so that they have sufficient depth in the PCB to retain the liquid metal 110 and to provide the gaps to ensure reduced compression forces for an electrical connection. The vias 108 may include the liquid metal 110 that is liquid at operating temperatures of components 118 of the silicon package 150. The receiving connector 102 may be able to receive the pins 112 of an external connector 104 into the vias 108 through matching apertures 120 of a seal 114. The liquid metal 110 may be able to make up an electrical connection with the pins and may allow signals and power from the external connector 104 to component 118. FIG. 1B also illustrates that the liquid metal 110 may be applied using a delivery format 152 having liquid chambers filled with liquid metal 110 that may be readily transferred by pressure, capillary action, or other transfer process to the vias 108.

FIG. 1B also illustrates that a receiving connector 102 may be formed, in part, by vias 108 within the PCB 106 to receive legacy external connectors having extended pins 112, in one example. The vias may include the liquid metal 110 that is liquid at operating temperatures of components 118 of the PCB 106. A frame having a flange may be associated between the PCB 106 and the external connector 104 to maintain the compression forces, which remain less than a comparable compression required for a comparable hard metal connector interface between the pins 112 and the PCB 106.

FIG. 1B also illustrates that an external connector 104 may include pins 112 specifically provided to make up an electrical connection with liquid metal 110 of a receiving connector 102. For example, the external connector 104 may be formed with pins 112 dimensioned to not contact the via walls 124 of the vias 108. The vias 108 include the liquid metal 110, which may be included prior to the electrical connection being made up. The liquid metal 110 is liquid at operating temperatures of components 118 of the PCB 106. The external connector 104 is, therefore, adapted to compress a seal 114 against the receiving connector 102 while being devoid of a compression force through the pins 112 within the vias 108. This is at least because surface tension may be relied upon for the electrical connection without need for the pins to physically contact any hard metal connector interface, such as a receiving socket.

FIG. 1B also illustrates a system that may be used to make up electrical connections using a liquid metal. The system may include the PCB 106 having the vias 108 which may be provided with liquid metal 110 of a predetermined quantity to allow electrical connection and surface tension around a pin 112, for instance. The predetermined quantity may be to ensure that, in one example, the liquid metal 110 rises to a predetermined height or contacts a predetermined length of the pins 112. The system includes a receiving connector 102 which may be formed, in part, by the vias 108 within the PCB 106 with the vias 108 having the liquid metal 110 that is liquid at operating temperatures of components 118 of the PCB 106. The receiving connector 102 may include the pins 112 of predetermined dimensions, as in FIG. 1C, to not contact the via walls 124 and the bottom of the vias 108. The receiving connector 102 may receive the pins 112 of the external connector 104 into the vias.

FIG. 1C illustrates detailed aspects 100C of liquid metal circuit board connectors, in accordance with at least some embodiments. As illustrated, a format or array of vias 108 may be determined to make a suitable contact for a specific format of a connection, such as NVLINK5 connection from Nvidia®. In another example, the connectors herein may support different media of transmission. A medium of transmission as used herein may allow networking capabilities associated with direct attach copper (DAC), active copper cable (ACC), active optical cables (AOCs), cable assembly with OSFP connectors or the like) or interconnect utilized by switch modules (including PCB connectors forming a board-to-board connection or a cabled header forming a board-to-cabled connection). The network connectors may each be configured to connect to a networking device of any type (e.g., QSFP, Direct Attach Copper, active optical cables (AOC), etc.), and may thus be dimensioned (e.g., sized and shaped) to mate with or otherwise connect to any corresponding networking device. The cable connector may be of any type (e.g., an AOC connector, Ethernet connector, Direct Attach Copper connector, Active Optical Module, or the like). A PCB is used to electrically connect electronic components using conductive pathways, or traces, etched from metal sheets. In many electronic systems, one or more very large-scale integrated circuit (“VLSI”) components are coupled to a host system printed circuit board (“PCB”). Such VLSI components may include, for example, central processing unit (“CPU) devices and graphics processing unit (“GPU”) devices. The PCB may hold at least one processing circuitry. The processing circuitry may comprise hardware, such as an application specific integrated circuit (ASIC). The processing circuitry may comprise an ASIC and/or may be capable of performing as a central processing unit (CPU), a graphics processing unit (GPU), a network interface controller (NIC), a data processing unit (DPU), or any other computing device in which with data is received and/or transmitted. Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. It should be appreciated that any appropriate type of electrical or optical component or collection of electrical or optical components may be suitable for inclusion in the processing circuitry. Numerous example embodiments will be described below in which a semiconductor package is mounted within a liquid metal via of a PCB. Although PCBs having certain types and form factors appear in the drawings and the discussion, it should be noted that the illustrated and described types and form factors are provided by way of example only. Persons having skill in the art and having reference to this disclosure will readily appreciate that the same or similar apparatus and techniques may also be employed with PCBs having other types and form factors. For example, in some embodiments, the PCB to which the semiconductor package is mounted may comprise an add-in card, such as a PCIe card, that is configured to be coupled to a system board or motherboard of a host system. In other embodiments, the PCB to which the semiconductor package is mounted may be the system board or motherboard of the host system itself. Moreover, the system board or the motherboard may be associated with any type of host system. For example, the PCB may comprise the system board in a multi-node rack-mounted server, or it may comprise the motherboard of a workstation, desktop, laptop, or mobile device. Other embodiments are also possible.

Once a determination of the format or array of vias 108 is determined, the PCB 106 may be subject to chemical etching, laser etching, or other suitable approaches to provide the vias in the format or array determined. For example, a determination of the receiving connector 102 having vias 108 in the format or array may be made and having predetermined via dimensions 176 may be made. The via dimensions 176 may include the via hole 174 and the via depth. Similarly, a determination of the receiving connector 102 having pins 112 in the format or array may be made and having predetermined pin dimensions 172 may be made. A seal 114 may be prepared with consideration of the format or array to provide the matching apertures 120. This allows a suitable connection to any of the formats required to support legacy or non-legacy electrical connections for signals and power.

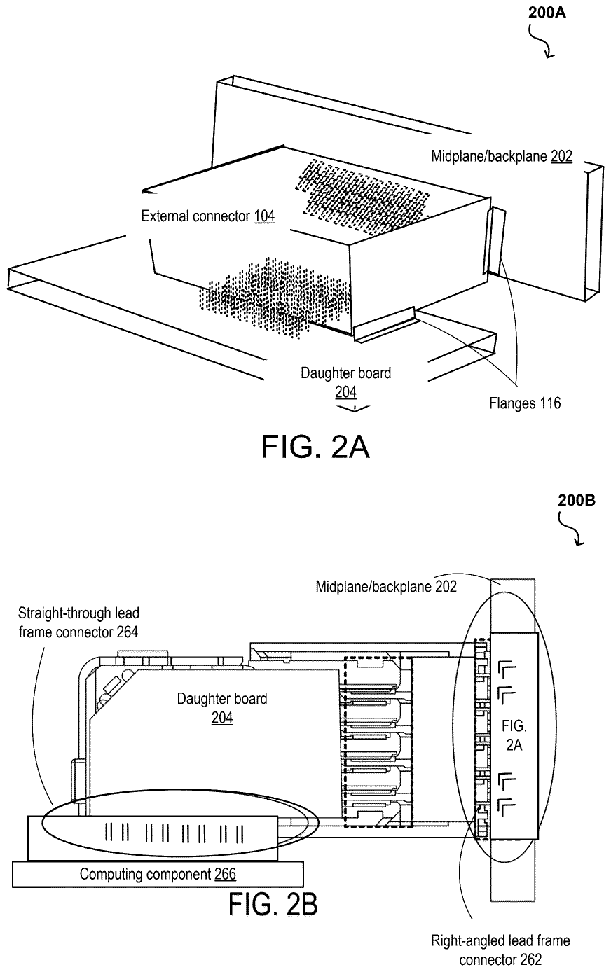

The receiving and the external connectors 102, 104 in FIGS. 1A-1C may be on a daughter board (as illustrated in at least FIG. 2A). The receiving connector 102 illustrated may be on the midplane or backplane 202 to allow receipt of the external connector 104 for transmitting data signals and for providing a ground reference or power between the daughter board and the midplane or backplane 202. The external connector 104 may be affixed to the midplane or backplane 202 using flanges that may be screwed or tethered with at least a compression force to keep the seal 114 in place but without exceeding a compression force otherwise required to maintain a compression contact for hard metal connectors, such as a pin inserted with fully contact against side of a receiving socket.

FIG. 1C also illustrates that each via 108 and/or each via hole 174 may be associated with a metal via overlay 180 and a metal lining 178. One or more of the metal via overlay 180 or the metal lining 178 may contact that the liquid metal 110, at least when the pins 112 are fully coupled with the vias 108. One or more of the metal via overlay 180 and the metal lining 178 may be coupled to the connection traces 126 of the PCB 106 to allow electrical coupling between the pins 112 and the connection traces 126 via the liquid metal 110. In another example, the metal via overlay 180 or the metal lining 178 may be at a bottom or in a layer under the top surface 132 of the PCB 106 and may perform the same function to allow electrical coupling between the pins 112 and the connection traces 126 via the liquid metal 110.

In one example, the PCB 106 may be a multi-layer PCB having an inner layer core formed of one or more of plastic, epoxy, or fiberglass. In some examples, thin sheets of fiberglass epoxy laminate (such as FR-4) may be used. In some examples, the sheets may be clad with copper foil on one or both sides providing inner layers for connection traces or interconnection. Photo-etching may be performed using a photoresist applied to thin sheets. A phototool may be placed over the photoresist and the thin sheets may be exposed to high-intensity ultraviolet (UV) light to harden the photoresist in the areas to be maintained as the connection traces or the interconnects and as the surface contact pads. The unhardened photoresist may be removed to expose other areas of copper. A chemical etching may be formed over the exposed other areas to remove the unwanted copper. The etching may be also performed to form the vias 108 through the sheets. A stacking and bonding (such as by lamination) may pe performed to the sheets.

In some examples, in the stacking and bonding process or step, the multiple layers may be combined in an intended order so that the vias are as intended. In some examples, the sheets may include a fiberglass cloth impregnated with partially cured epoxy resin placed between layers to provide an insulating glue. The stacked layers may be placed into a lamination press. Under pressure and high temperature, the resin from the insulating glue may flow and fill gaps in the layers. The resin may cure to bond the entire stack into a single solid multi-layer board having the vias 108 through one or more of the layers.

In some examples, drilling may be performed after the PCB 106 is formed as a multi-layer PCB. For instance, with the layers bonded, the vias 108 may be are drilled through the laminated layers but through at most one layer of at least two layers. The vias may be from one side and may serve two the purpose of providing further aspects of the liquid metal connections herein. The drilling may be performed by computer-controlled drills. This may be followed by cleaning and copper deposition (such as by plating or another suitable process). In one example, a thin layer of copper may be deposited chemically over the entire laminated and stacked layers, including inside the drilled vias. This may be an electroless copper deposition process to create a conductive base for the liquid metal to couple to allow connection between the pins and the receiving connector 102.

FIG. 1D illustrates aspects 100D of a receiving connector having vias with liquid metal, in accordance with at least some embodiments. The receiving connector 102 may be an area on a PCB 106 which may be formed, in part, by vias 108 within the PCB 106. The vias 108 may include a liquid metal 110 that is liquid at operating temperatures of components of the PCB 106. The receiving connector 102 may receive 180 pins 112 of an external connector 104 into the vias 108. The liquid metal 110 in the vias 108 may make up an electrical connection with the pins for signals or power or a combination thereof. FIG. 1D also illustrates that the PCB 106 may be a double-sided or multi-layer PCB with a via 108 being coupled to intermediate layers (having connection traces 126) for signal termination or other signaling or power purposes. The via 108 may be open to receive pins 112 from both sides of the PCB 106 to contact liquid metal 110 applied into a stubless connection 182 via, to one side or to both sides, in separate steps or as part of a single step. FIG. 1D illustrates that the receiving connector 102 may extend from a first side to a second side (such as an opposite side) of the PCB 106.

FIG. 2A illustrates a connection 200A between two circuit boards and used for differential signaling by a lead frame connector, in accordance with at least some embodiments. One of the circuit boards may be a midplane or a backplane 202 and another one of the circuit boards may be a daughter board 204. The lead frame connector may be an external connector 104 with pins on either side to fit within vias of the midplane or a backplane 202 and of the daughter board 204. As illustrated, the lead frame connector may be held down by flanges 116 on its ends. In another example, an external tie or other external retainers may be used between the circuit boards and the lead frame connector.

The external tie, flanges 116, other external retainers may function to retain or restrict the lead frame connector from disconnection or movement away from a receiving connector 102 of a circuit board and may do so with less than the compression force otherwise required to maintain a compression contact for hard metal connectors, such as a pin inserted with fully contact against side of a receiving socket. On at least the daughter board 204, the receiving connector may be associated with surface contact pads 136 of associated components 118. On the midplane or the backplane, the surface contact pads 136 may be aligned with its own receiving connector and to allow a connection from a lead frame connector to components between the midplane or a backplane 202 and the daughter board 204.

FIG. 2B illustrates a connection 200B between a daughter board and a backplane or a midplane and other computing components, in accordance with at least some embodiments. FIG. 2B illustrates the use of a right-angled lead frame connector 262 between a daughter board 204 and a midplane or backplane 202. The right-angled lead frame connector 262 may be as described in connection with FIG. 2A, and specifically, as to the lead frame connector in FIG. 2A. FIG. 2B also illustrates the use of a straight-through lead frame connector 264. The straight-through lead frame connector 264 may be provided between computing components 266 and the daughter board 204. The computing components may be adapters, memory sticks, communication cards, and others that may be intended for use with a daughter board 204 or the midplane or backplane 202, through the daughter board 204.

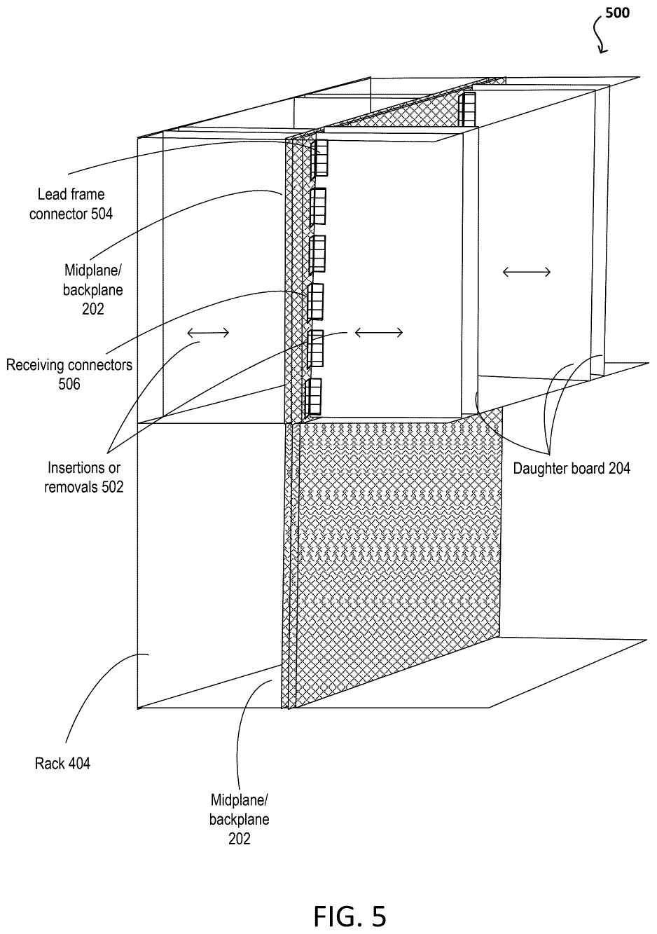

Each of the right-angled lead frame connector 262 and the straight-through lead frame connector 264 may include integration of the liquid metal circuit board connectors as part of its lead frame connector's pins and as part of the liquid metal vias, as discussed in detail with one or more of FIGS. 1A-1D. In at least one example, the pin 112 in each external connector 104 of the right-angled lead frame connector 262 and the straight-through lead frame connector 264 may extend from the external connector 104 to fit within the vias 108 without contacting the via walls 124. The electrical contact may be made between the pins and the liquid metal to pass signals from the circuit boards and through the connector. The midplane or a backplane 202 may belong to a rack in a datacenter, which is detailed further in at least FIG. 5.

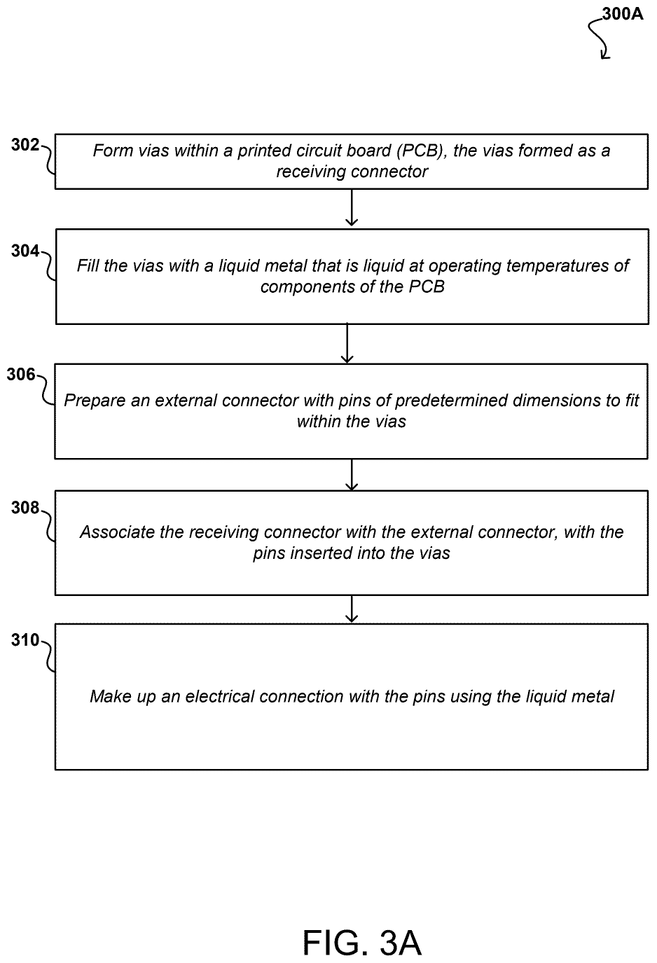

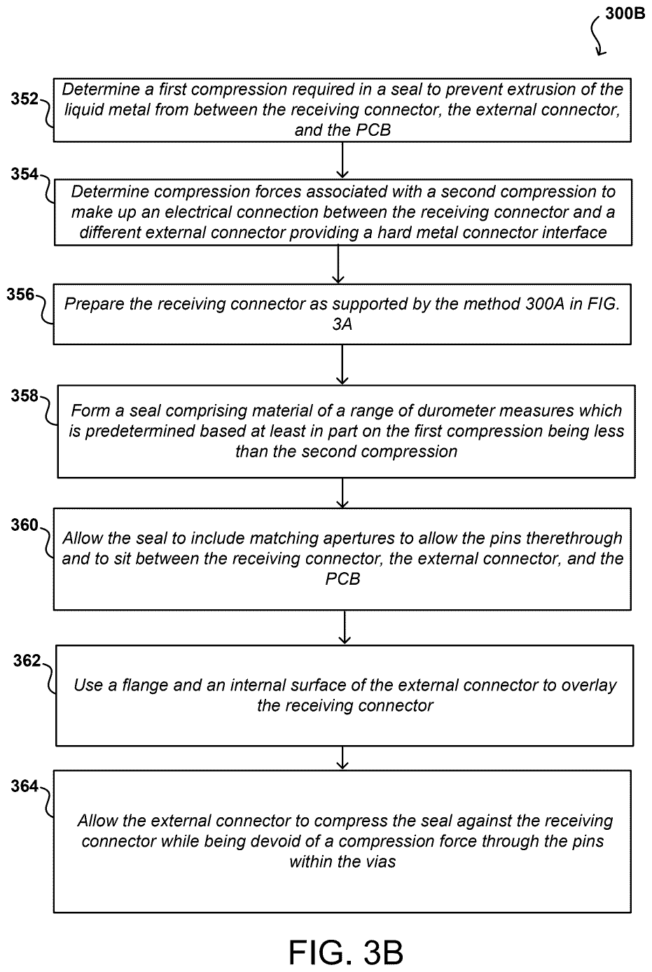

FIG. 3A illustrates a process or method 300A for liquid metal circuit board connectors, in accordance with at least some embodiments. For instance, the method 300A may include a step to form 302 vias within a PCB. The vias may be formed as part of or may define an area in the PCB as a receiving connector. The method 300A may include a step to fill 304 the vias with a liquid metal that is liquid at operating temperatures of components of the PCB. The method 300A may include a step to prepare 306 an external connector with pins of predetermined dimensions to fit within the vias. The method 300A may include a step to associate 308 the receiving connector with the external connector, with the pins inserted into the vias. The association 308 or a different step may be used to make up 310 an electrical connection with the pins using the liquid metal. For example, the association to a certain depth allows the electrical connection that is devoid of reflective signal interference from signal bouncing within the stubs.

FIG. 3B illustrates another process or method 300B for liquid metal circuit board connectors, in accordance with at least some embodiments. The method 300B in FIG. 3B may be used with the method 300A in FIG. 3A. The method 300B may provide a connector for signaling or power. The method 300B may include a step to determine 352 a first compression required in a seal to prevent extrusion of the liquid metal from between the receiving connector, the external connector, and the PCB. The method 300B may include a step to determine 354 compression forces associated with a second compression to make up an electrical connection between the receiving connector and a different external connector providing a hard metal connector interface. The method 300B may include a step to prepare 356 the receiving connector as supported by the method 300A in FIG. 3A. The method 300B may include a step to form 358 a seal including material of a range of durometer measures which is predetermined based at least in part on the first compression being less than the second compression. The method 300B may include a step to allow 360 the seal to include matching apertures to allow the pins therethrough and to sit between the receiving connector, the external connector, and the PCB. The method 300B may include a step to use 362 a flange and an internal surface of the external connector to overlay the receiving connector. The method 300B may include a step to allow 364 the external connector to compress the seal against the receiving connector while being devoid of a compression force through the pins within the vias.

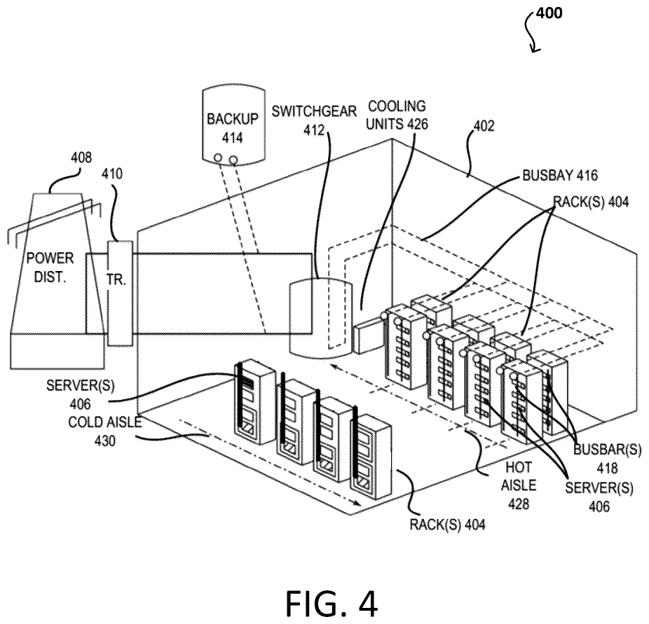

FIG. 4 illustrates an example datacenter to apply at least one embodiment for power connection in FIGS. 1A-3B and 5-7. The datacenter 400 may include racks 404 that may be associated with servers 406 therein (in a server tray, server box, or server/computer module format), and that may include compute devices therein to perform a workload. Although illustrated as horizontal features, the servers 406 may be vertically provided within a rack 404. Such racks 404 may be tied (such as hardwired or natively within rows of racks) as part of the infrastructure of the datacenter 400. For instance, the racks 404 may be associated with power supply units (PSUs) and may be associated with a busbay 416 to receive and distribute power for the servers 406, these racks 404 may necessarily include power components (such as busbars 418) that are intimately associated with the racks 404. The power components may be part of the infrastructure of the datacenter 400. The racks 404 may include high-speed interconnect, enabling high-speed communication between subsystems, including the servers 406.

The compute devices may be provided on circuit boards and may include processors (such as central processing units (CPUs), quantum processing units (QPUs), graphics processing units (GPUs), data processing units (DPUs), application-specific integrated circuits (ASICs), field-programmable gate arrays (FPGAs), physics processing units (PPUs), or the like), and other components (such as memory, communication modules, input/output modules, and the like).

In at least one embodiment, the datacenter 400 may include one or more rooms 402 of racks 404, where the racks 404 may include server trays or servers 406. The datacenter 400 may be powered from a power distribution 408 system, via one or more transformers 410 (Tr.), so that the power to a switchgear 412 may be suitable for the datacenter. For instance, the power distribution 408 system may be part of a transmission system. The transmission system may provide high-voltage electricity from a utility grid. Each transformer 410 may step down the voltage to a level suitable for the datacenter's equipment and devices, such as the aforementioned processors that may be in the server trays or servers 406 in each rack 404. The switchgear 412 may be able to control, protect, and isolate power in both downstream and upstream directions.

The switchgear 412 may be used to manage flow of electricity in a reliable and efficient manner using switching of electrical circuits for controls and using breakers and fuses to detect and respond to faults or overloads in both downstream and upstream directions. In addition to an external source represented by the transmission systems and to ensure uninterrupted power supply, a backup 414 system, such as a generator or Uninterruptible Power Supply (UPS), may be used with the power distribution 408 system (Power Dist.). In addition, a cooling unit 426 may provide at least air cooling for the cold aisle 430 side and pass through the racks 404 to the hot aisle 428 side of the datacenter 400. The movement of the air cooling may be supported by fans, in one example.

The switchgear 412 may be associated with the busbay 416. The busbay 416 may provide power to one or more racks 404. In one example, the busbay 416 may provide power to one or more racks 404 through provided busbars 418. The busbars 418 may be conductive bars that carry electrical current to various loads, including those represented by the aforementioned processors, which may be within the server trays or computer modules (also referenced as servers 406) in each rack 404 of the datacenter 400. The busbars 418 may be provided from copper, aluminum, or a suitable power delivery material. The busbars 418 may be able to work together to handle the high-current demands of the datacenter 400.

The datacenter 400 may include a midplane or a backplane 202, as in FIGS. 2A, 2B, and the related discussions. The midplane or the backplane 202 may have the surface contact pads to receive the lead frame connectors (such as the external connectors in FIGS. 1A-1D) between other circuit boards (such as the daughter boards 204 in FIGS. 2A and 2B) or from other components of the datacenter. These components may include power components as described herein and the computing components 266, as described in connection with FIG. 2B, for instance. The midplane or the backplane 202 may be associated with receiving connectors having liquid metal within vias to receive lead frame connectors of the daughter boards 204, where multiple daughter boards 204 may be plugged into the midplane or backplane 202. The lead frame connectors may include individual pins to fit within the vias. The pins may connect to contact surface contact pads on a component side, in one example. The receiving connector may be formed, in part, by vias within the midplane or the backplane 202. The liquid metal in the vias is a liquid at operating temperatures of components of the midplane or the backplane 202. The external connector with its pins may be such that the pins fit into the vias of all the intended receiving connectors. This allows the liquid metal of the vias to make up different electrical connections with the pins.

FIG. 5 illustrates aspects 500 of an example rack to apply at least one embodiment in FIGS. 1A-4 and 6A-7. The aspects 500 illustrate that a rack 404 may have at least one circuit board that may be a midplane or a backplane 202. Although illustrated as open, the rack 404 may be fully enclosed with front, back, side, and top covers or access panels. Also, although illustrated at a high-level flat structure, the circuit board may include at least one PCB (also, as illustrated and described in at least FIGS. 2A and 2B). When used as a backplane, a circuit board may include a single side of receiving connectors 506 to receive lead frame connectors 504 of the daughter boards or cards 204. When used as a midplane, the circuit board may include two sides of receiving connectors 506 to receive lead frame connectors 504 of the daughter boards or cards 204 on both sides of the circuit board. In the aspects 500 in FIG. 5, the circuit board is a midplane which is located at a middle of a rack 404. The midplane may receive servers 406 in a vertical board format or daughter boards 204, which may be pushed for insertion 502 against the receiving connectors 506, for instance, of the midplane forming one or many connections between the midplane and the servers or the daughter boards 204.

FIG. 5, along with FIGS. 1A-1D also illustrate aspects 500 of a datacenter having a midplane or a backplane 202 and one or more daughter boards 204, along with the liquid metal connections within the connectors (as in FIGS. 1A-1D). The midplane or a backplane 202 may include signal surface contact pads for differential signals and ground surface contact pads, channels, or lines. The midplane or a backplane 202 may include receiving connectors 506 individually associated with the ground surface contact pads, channels, or lines. The one or more daughter boards 204 may be coupled to the midplane or backplane 202 through a lead frame connector 504. The lead frame connectors 504 may include the pins arranged in an array. The receiving connectors 506 may include vias filled with liquid metal to receive the pins. There may be flanges to hold the lead frame connectors 504 to the receiving connectors 506 with a seal in between. FIG. 5 illustrates that, because surface tension of the liquid metal is used as one basis for electrical connection, the orientation of the lead frame connectors 504 and of the receiving connectors 506 is not restricted.

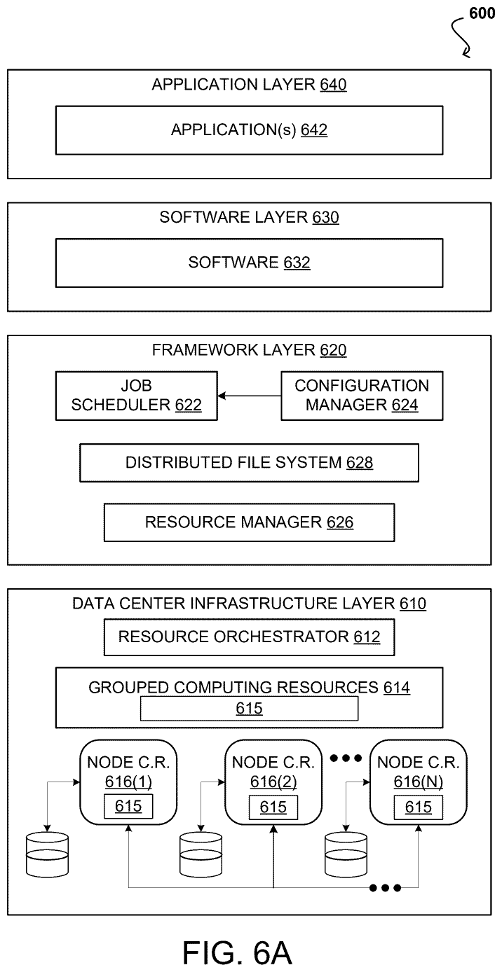

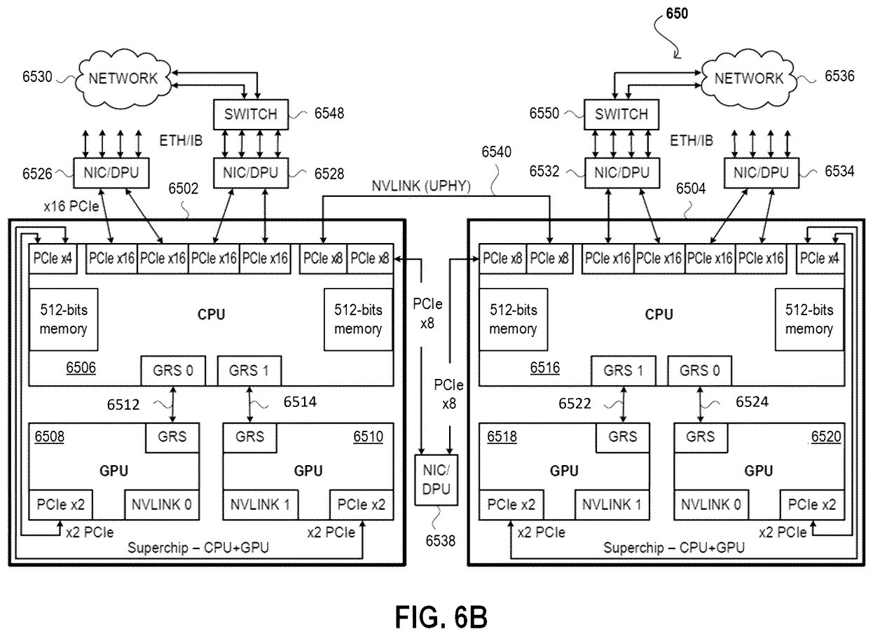

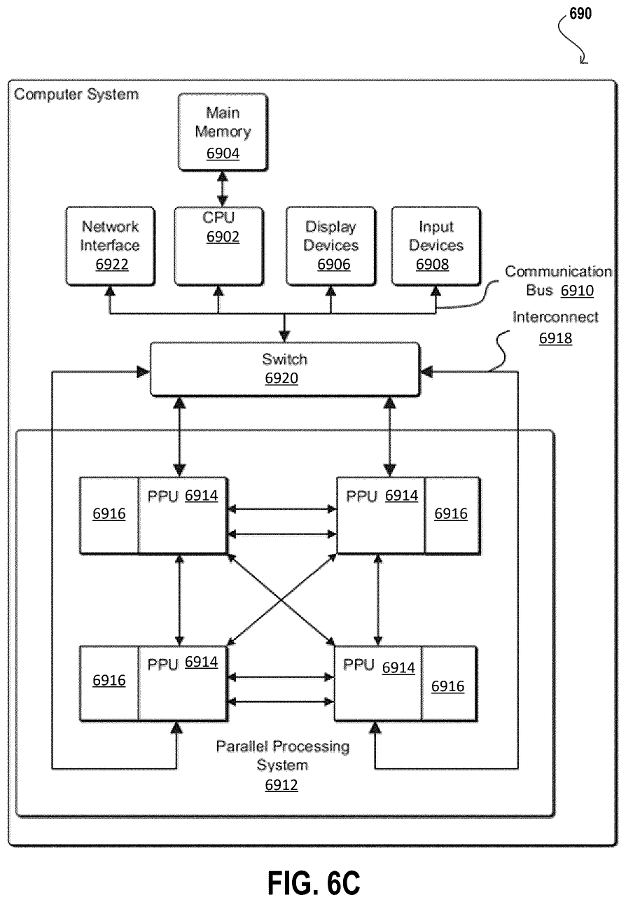

FIG. 6A illustrates an example datacenter 600, in which at least one embodiment may be used. In at least one embodiment, datacenter 600 includes a datacenter infrastructure layer 610, a framework layer 620, a software layer 630, and an application layer 640. FIG. 6A illustrates an example datacenter 600, in which at least one embodiment may be used. In at least one embodiment, datacenter 600 includes a datacenter infrastructure layer 610, a framework layer 620, a software layer 630, and an application layer 640. A datacenter 600 may include one or more racks, such as described in connection with at least FIGS. 4 and 5. The racks may include one or more server trays. There may be one or more electronic components in the one or more server trays to perform at least part of a workload in the datacenter. The racks and server trays may be represented by at least the datacenter infrastructure layer 610. The electronic components may be presented by the node computing resources 616(1)-616(N) that may be subject to cooling using cold plates.

In at least one embodiment, as shown in FIG. 6A, datacenter infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in datacenters at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for datacenter 600. In at least one embodiment, resource orchestrator may include hardware, software or some combination thereof.

In at least one embodiment, as shown in FIG. 6A, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may use distributed file system 628 for large-scale data processing (e.g., “big data”). In at least one embodiment, job scheduler 622 may include a Spark driver to facilitate scheduling of workloads supported by various layers of datacenter 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resources 614 at datacenter infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. The one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a datacenter operator of datacenter 600 from making possibly bad configuration decisions and possibly avoiding underused and/or poor performing portions of a datacenter.

In at least one embodiment, datacenter 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 600. In at least one embodiment, trained machine learning models corresponding to one or more neural networks may be used to infer or predict information using resources described above with respect to datacenter 600 by using weight parameters calculated through one or more training techniques described herein.

In at least one embodiment, datacenter may use CPUs, application-specific integrated circuits (ASICs), GPUs, FPGAs, DPUs, QPUs or PPUs, or other hardware to perform training and/or inferencing using above-described resources. Moreover, one or more software and/or hardware resources described above may be configured as a service to allow users to train or perform inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 6A for inferencing or predicting operations based, at least in part, on weight parameters calculated using neural network training operations, neural network functions and/or architectures, or neural network use cases described herein.

FIG. 6B is a block diagram that schematically illustrates a computing system that may be a datacenter or a High-Performance Computing (HPC) cluster, in which at least one embodiment from FIGS. 1A-5 may be used. The computing system 650 may include a plurality of subsystems, e.g., multiple processing devices coupled to each other, multiple network devices, and multiple networks, according to at least some embodiments. The computing system 650 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 650 and to one or more external networks 6530, 6536. In the present example, computing system 650 comprises a packet switch 6548 that connects NIC/DPU 6528 to external network 6530, and a packet switch 6550 that connects NIC/DPU 6532 to external network 6536.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 650 can include one or more CPUs and one or more GPUs.

FIG. 6B also demonstrates an example architecture of a multi-GPU architecture. As illustrated in the figure, computing system 650 includes a processing device 6502 with a multi-GPU architecture. In particular, processing device 6502 may be a system-on-chip and includes multiple subsystems such as a CPU 6506, a GPU 6508, and a GPU 6510. CPU 6506 can be coupled to GPU 6508 via a die-to-die (D2D) or chip-to-chip (C2C) interconnect 6512, such as a Ground-Referenced Signaling interconnect (GRS interconnect). CPU 6506 can be coupled to GPU 6510 via a D2D or C2C interconnect 6514. CPU 6506 can also couple to GPU 6508 and GPU 6510 via PCIe interconnects.

CPU 6506 can be coupled to one or more NICs or DPUs, which are coupled to one or more networks. For example, as illustrated in FIG. 6B, CPU 6506 is coupled to a first NIC/DPU 6526, which is coupled to an external network 6530. CPU 6506 is also coupled to a second NIC/DPU 6528, which is coupled to external network 6530 via packet switch 6548. NIC/DPU 6526 and NIC/DPU 6528 can be coupled to external network 6530 over Ethernet (ETH), NVLINK or InfiniBand (IB) connections, for example.

Computing system 650 also includes a processing device 6504 with a multi-GPU architecture. In particular, processing device 6504 includes multiple subsystems including a CPU 6516, a GPU 6518, and a GPU 6520. CPU 6516 can be coupled to GPU 6518 via a D2D or C2C interconnect 6522. CPU 6516 can be coupled to GPU 6520 via a D2D or C2C interconnect 6524. CPU 6516 can also couple to GPU 6518 and GPU 6520 via PCIe interconnects. CPU 6516 can be coupled to one or more NICs or DPUs, which are coupled to one or more networks. For example, as illustrated in FIG. 6B, CPU 6516 is coupled to a first NIC/DPU 6532, which is coupled to an external network 6536. CPU 6516 is also coupled to a second NIC/DPU 6534, which is coupled to the external network 6536 via packet switch 6550. NIC/DPU 6532 and NIC/DPU 6534 can be coupled to the external network 6536 over Ethernet (ETH), NVLINK or InfiniBand (IB) connections.

In at least one embodiment, processing device 6502 and processing device 6504 can communicate with each other via a NIC/DPU 6538, such as over PCIe interconnects. Processing device 6502 and processing device 6504 can also communicate with each other over a high-bandwidth communication interconnects 6540, such as an NVLink interconnect or other high-speed interconnects. The packet switches in FIG. 6B may comprise, for example, Nvidia Quantum-2 switches. The NICs/DPUs in the figure may comprise, for example, Nvidia Bluefield DPUs.

In various embodiments, any of the network devices of the computing system 650, e.g., any of NICs/DPUs 6526, 6528, 6532, 6534 and 6538, and/or any of packet switches 6548 and 6550, may include a shaped leak sensor that can match a geometry around components and features in the computing system 650 and that can be communicatively coupled together to extend leak detection capabilities.

FIG. 6C illustrates a computer system, according to at least one example, in which at least one embodiment from FIGS. 1A-6B and 7 may be used. In at least one embodiment, computer system 690 is configured to implement various processes and methods described throughout this disclosure.

In at least one embodiment, computer system 690 comprises, without limitation, at least one central processing unit (“CPU”) 6902 that is connected to a communication bus 6910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 690 includes, without limitation, a main memory 6904 and control logic (e.g., implemented as hardware, software, or a combination thereof) and data are stored in main memory 6904 which may take form of random access memory (“RAM”). In at least one embodiment, a network interface subsystem (“network interface”) 6922 provides an interface to other computing devices and networks for receiving data from and transmitting data to other systems from computer system 690.

In at least one embodiment, computer system 690, in at least one embodiment, includes, without limitation, input devices 6908, parallel processing system 6912, and display devices 6906 which can be implemented using a conventional cathode ray tube (“CRT”), liquid crystal display (“LCD”), light emitting diode (“LED”), plasma display, or other suitable display technologies. In at least one embodiment, user input is received from input devices 6908 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 6904 and/or secondary storage. Computer programs, if executed by one or more processors, enable computer system 690 to perform various functions in accordance with at least some embodiments. Main memory 6904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 6902; parallel processing system 6912; an integrated circuit capable of at least a portion of capabilities of both CPU 6902; parallel processing system 6912; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 690 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 6912 includes, without limitation, a plurality of parallel processing units (“PPUs”) 6914 and associated memories 6916. In at least one embodiment, PPUs 6914 are connected to a host processor or other peripheral devices via an interconnect 6918 and a switch 6920 or multiplexer. In at least one embodiment, parallel processing system 6912 distributes computational tasks across PPUs 6914 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 6914, although such shared memory may incur performance penalties relative to use of local memory and registers resident to a PPU 6914. In at least one embodiment, operation of PPUs 6914 is synchronized through use of a command such as_syncthreads( ), wherein all threads in a block (e.g., executed across multiple PPUs 6914) to reach a certain point of execution of code before proceeding.

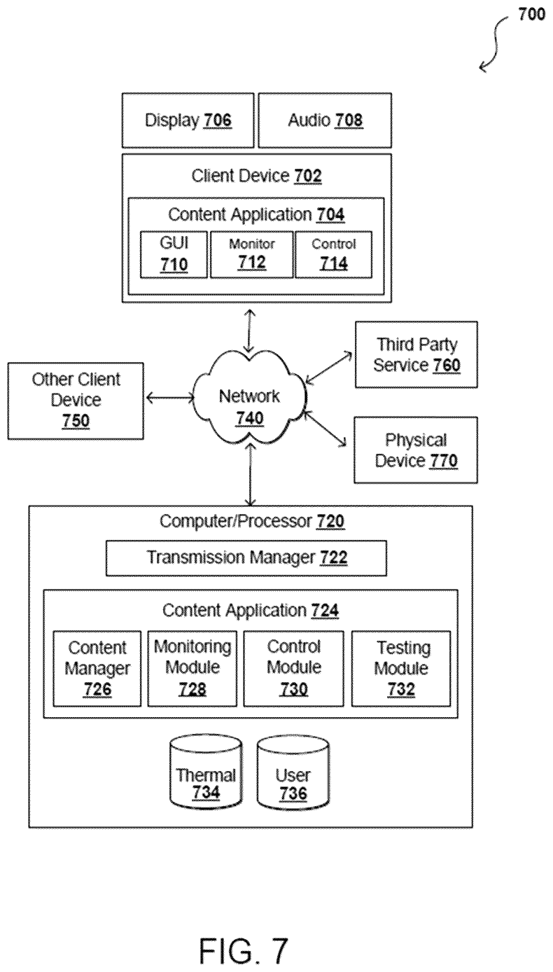

FIG. 7 illustrates an example network configuration 700 of components that can be used to implement aspects of various embodiments, such as to provide, generate, modify, encode, process, fuse, and/or transmit generated image data, calculated measurements, or other such content. In at least one embodiment, a client device 702 can generate or receive data for a session using components of a content application 704 on the client device 702 and data stored locally on that client device. In at least one embodiment, a content application 724 executing on a computer or processor 720 (e.g., a cloud server or control system) may initiate a session associated with at least one client device 702 (e.g., a vehicle or robot), as may use a session manager and user data stored in a user database 736, and can cause content such as liquid coolant or server thermal data to be selected and/or retrieved from a thermal repository 734 to be used by a testing module 732 to calculate one or more performance metrics for a monitoring module 728, which can provide flow data or thermal data to a control module 730 to control a flow or temperature, in an environment where the data is to be used to determine appropriate operation. A content manager 726 may work with these various modules to perform testing and analysis, and potentially instruct any actions to be taken in response to a performance metric failing to satisfy an operational requirement. At least a portion of this data or instructional content can be transmitted to the client device 702 and/or a physical device 770 using an appropriate transmission manager 722 to send by download, streaming, or another such transmission channel. An encoder may be used to encode and/or compress at least some of this data before transmitting to the client device 702. In at least one embodiment, the client device 702 receiving such content can provide this content to a corresponding content application 704, which may also or alternatively include a graphical user interface (GUI) 710, a flow monitor module 712, and a control module 714 for use in providing, synthesizing, rendering, compositing, modifying, or using content for presentation, navigation, control, (or other purposes) on or by the client device 702, such as may be transmitted to the physical device 770. In some embodiments, the computer/processor 720 and client device 702 may be able to communicate directly without needing to transmit data over a network 740, in order to avoid issues with latency and availability, etc. A decoder may also be used to decode data received over the network 740 for presentation via client device 702, such as imaging content or performance metrics through a display device 706 and audio, such as corresponding sounds or synthesized speech, through at least one audio playback device 708, such as speakers or headphones. In at least one embodiment, at least some of this content may already be stored on, rendered on, or accessible to client device 702 such that transmission over a network 740 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer/processor 720, or user database 736, to the client device 702. In at least one embodiment, at least a portion of this content can be obtained, enhanced, and/or streamed from another source, such as a third party service 760 or other client device 750, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit).

In at least one embodiment, a cold plate herein may include adjustable fins forming microchannels for fluid to flow through. In at least one embodiment, fins in a cold plate allow transfer of heat from at least one associated computing device to a fluid flowing through microchannels formed between multiple fins. In at least one embodiment, fins of a cold plate are dynamically and adjustable in real time to allow transfer of more heat from at least one computing device to a fluid that flows through a cold plate having fins. In at least one embodiment, such fins may be adjusted by a processor or processorless system based in part on a temperature determined, such as sensed, for a cold plate. In at least one embodiment, a temperature may be associated with at least one computing device, a workload of at least one computing device, or a fluid at different time periods and at an entry, and at an egress of a cold plate. In at least one embodiment, a processorless system may rely on a thermal property of at least two materials used to form fins for a cold plate so that such fins may react without a processor to cause exposure of more surface area to a fluid. In at least one embodiment, such fins may include an overlapping portion that may be caused to be exposed by action of a control mechanism or by properties of at least two materials associated together to form a fin.

In at least some of these examples, client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a datacenter or server farm. In at least one embodiment, the request may be received or processed by at least one edge server, which sits on a network edge and is outside at least one security layer associated with the cloud provider environment. In this way, latency can be reduced by allowing the client devices to interact with servers that are in closer proximity, while also improving security of resources in the cloud provider environment.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU, GPU, DPUs, QPUs, or PPUs. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A circuit board assembly comprising a receiving connector formed, in part, by vias within a printed circuit board (PCB), wherein the vias comprise a liquid metal that is liquid at operating temperatures of components of the PCB, wherein the receiving connector is to receive pins of an external connector into the vias, and wherein the liquid metal is to make up an electrical connection with the pins.

2. The circuit board assembly of claim 1, further comprising:
a seal comprising material of a range of durometer measures which is predetermined based at least in part on a first compression required to the seal to prevent extrusion of the liquid metal from between the receiving connector, the external connector, and the PCB, wherein the first compression is less than a second compression required for a comparable hard metal connector interface between the pins and the PCB.

3. The circuit board assembly of claim 1, further comprising:
a seal comprising matching apertures to allow the pins therethrough and to sit between the receiving connector, the external connector, and the PCB.

4. The circuit board assembly of claim 1, wherein the liquid metal is one of a gallium-based composition or a metal-based thermal interface metal (TIMs) which are liquid at an operating temperature of the PCB.

5. The circuit board assembly of claim 1, wherein the external connector comprises a flange and an internal surface to overlay the receiving connector, wherein the external connector is adapted to compress a seal against the receiving connector while being devoid of a compression force through the pins within the vias.

6. The circuit board assembly of claim 1, wherein the liquid metal is to make up the electrical connection with the pins based in part on a surface tension available within the liquid metal.

7. The circuit board assembly of claim 1, wherein the vias comprising the liquid metal are stubless, and wherein the electrical connection allows a data rate communication that is free of reflective signal interference between the receiving connector and the external connector.

8. A receiving connector formed, in part, by vias within a printed circuit board (PCB), wherein the vias are to comprise a liquid metal that is liquid at operating temperatures of components of the PCB, wherein the receiving connector is to receive pins of an external connector into the vias, and wherein the liquid metal is to make up an electrical connection with the pins.

9. An external connector comprising pins to make up an electrical connection with liquid metal of a receiving connector which is formed, in part, by vias within a printed circuit board (PCB), wherein the vias comprise the liquid metal that is liquid at operating temperatures of components of the PCB, and wherein the external connector is adapted to compress a seal against the receiving connector while being devoid of a compression force through the pins within the vias.

10. A silicon package comprising a receiving connector formed, in part, by vias within the silicon package, wherein the vias are to comprise a liquid metal that is liquid at operating temperatures of components of the silicon package, wherein the receiving connector is to receive pins of an external connector into the vias, and wherein the liquid metal is to make up an electrical connection with the pins.

11. A system comprising:
a printed circuit board (PCB);
a receiving connector formed, in part, by vias within the PCB, wherein the vias comprise a liquid metal that is liquid at operating temperatures of components of the PCB; and
an external connector comprising pins, wherein the receiving connector is to receive the pins of the external connector into the vias, and wherein the liquid metal is to make up an electrical connection with the pins.

12. The system of claim 11, further comprising:
a seal comprising material of a range of durometer measures which is predetermined based at least in part on a first compression required to the seal to prevent extrusion of the liquid metal from between the receiving connector, the external connector, and the PCB, wherein the first compression is less than a second compression required for a comparable hard metal connector interface between the pins and the PCB.

13. The system of claim 11, further comprising:
a seal comprising matching apertures to allow the pins therethrough and to sit between the receiving connector, the external connector, and the PCB.

14. The system of claim 11, wherein the liquid metal is one of a gallium-based composition or a metal-based thermal interface metal (TIMs) which are liquid at an operating temperature of the PCB.

15. The system of claim 11, wherein the external connector comprises a flange and an internal surface to overlay the receiving connector, wherein the external connector is adapted to compress a seal against the receiving connector while being devoid of a compression force through the pins within the vias.

16. The system of claim 11, wherein the liquid metal is to make up the electrical connection with the pins based in part on a surface tension available within the liquid metal.

17. The system of claim 11, wherein the vias comprising the liquid metal are stubless, and wherein the electrical connection allows a data rate communication that is free of reflective signal interference between the receiving connector and the external connector.

18. A datacenter, comprising:
a midplane or a backplane within one or more racks in the datacenter;
a receiving connector formed, in part, by vias within the midplane or the backplane, wherein the vias comprise a liquid metal that is liquid at operating temperatures of components of the midplane or the backplane; and
an external connector comprising pins, wherein the receiving connector is to receive the pins of the external connector into the vias, and wherein the liquid metal is to make up an electrical connection with the pins.

19. A method comprising;
forming vias within a printed circuit board (PCB), the vias formed as a receiving connector;
filing the vias with a liquid metal that is liquid at operating temperatures of components of the PCB;
preparing an external connector with pins of predetermined dimensions to fit within the vias; and
associating the receiving connector with the external connector, with the pins inserted into the vias, and wherein the liquid metal is to make up an electrical connection with the pins.

20. The method of claim 19, further comprising one or more of:
forming a seal comprising material of a range of durometer measures which is predetermined based at least in part on a first compression required to the seal to prevent extrusion of the liquid metal from between the receiving connector, the external connector, and the PCB, wherein the first compression is less than a second compression required for a comparable hard metal connector interface between the pins and the PCB;
forming a seal comprising matching apertures to allow the pins therethrough and to sit between the receiving connector, the external connector, and the PCB;
using a flange and an internal surface of the external connector to overlay the receiving connector, wherein the external connector is adapted to compress the seal against the receiving connector while being devoid of a compression force through the pins within the vias;
determining a surface tension available within the liquid metal and allowing the electrical connection with the pins based in part on the surface tension available within the liquid metal; or
allowing the vias comprising the liquid metal to be stubless, wherein the electrical connection allows a data rate communication that is free of reflective signal interference between the receiving connector and the external connector.
